(19) United States
(12) Patent Application Publication
(10) Pub. No.: US 2003/0028417 A1
(43) Pub. Date: Feb. 6, 2003

(54) Method for evaluating retail locations

(76) Inventor: Edward J. Fox, Dallas, TX (US)

Correspondence Address: CARSTENS YEE & CAHOON, LLP, P O BOX 802334, DALLAS, TX, 75380

(21) Appl. No.: 10/137,524

(22) Filed: May 2, 2002

Related U.S. Application Data
(60) Provisional application No. 60/288,141, filed on May 2, 2001.

(51) Int. Cl. G06F 17/60

(52) U.S. Cl. 705/10

(57) ABSTRACT

The present invention comprises a novel business method for evaluating prospective commercial retail sites. The present invention assists in the evaluation and assessment of prospective sites by forecasting revenues and assessing impact on existing retail establishments. The present invention is also adaptable to forecasting the effects of closing a remotely located retail store based upon on the revenues of another existing store. The present invention overcomes many of the disadvantages of prior art more accurately correlating syndicated panel data to larger population groups.

### CROSS-REFERENCE TO RELATED APPLICATIONS

This application claims the benefit of and priority to U.S. Provisional Patent Application No. 60/288,141 filed May 2, 2001, the technical disclosure of which is hereby incorporated herein by reference.

### BACKGROUND OF THE INVENTION

1. Technical Field

The present invention relates generally to real estate appraisals and more particularly to a method for evaluating prospective commercial retail sites. The present invention assists in the evaluation and assessment of prospective sites by forecasting revenues and assessing impact on existing retail establishments.

2. Description of the Related Art

Retail location is an important determinant of shopping behavior. Indeed, some studies indicate that retail location variables explain nearly 50% of household spending across store chains. Thus, correctly choosing the proper location for a retail establishment is certainly one of the first, and perhaps the most important decision to ensuring the long term success of a prospective business.

A thorough review of the retail location variable, however, reveals a far more complicated variable than perhaps initially perceived. For example, retail location may be defined relative to customers or relative to other stores. One study indicates that given market penetration, agglomeration effects actually explain more spending variation than does a store's location relative to its shoppers. Agglomeration captures the countervailing effects of symbiosis and competition among retailers. Agglomeration may be either intra-type or inter-type. Intra-type agglomerations (e.g., “motor miles” and “restaurant rows”) occur when stores of the same type locate near one another, thereby facilitating consumer comparison and lower consumer uncertainty. Inter-type agglomerations (e.g., shopping centers and shopping malls) occur when stores of different types locate near one another, thereby facilitating multi-purpose shopping and offering consumers a wider variety of goods to choose from.

While distance from the store to the shopper's home is a common variable in virtually all previous models of retail competition and shopping behavior, in reality, shoppers often reduce their travel time by linking shopping trips together or combining store visits with other required travel. “Trip chaining”, as this practice is called, results in shoppers requiring less than the measured travel time to make a store visit, and possibly shopping more than expected at distant stores. Previous research using cross-sectional and panel data also suggests that demographics can influence price sensitivity.

Further complicating the retail location analysis is the effect of cross-format competition. For example, grocery stores, such as Kroger, Safeway, and Albertsons, operate in an increasingly competitive environment that includes many other retail formats. In addition to grocery stores, other common retail formats include drug stores (e.g., Walgreen's, CVS, Eckerd), and mass merchandisers (e.g., Wal-Mart, Target, Kmart). In particular, grocery retailers increasingly view alternative formats, such as mass merchandisers, as their main competitors. Mass merchandisers offer thousands of packaged goods products that are also found in grocery stores. As a format, mass merchandisers grew rapidly throughout the 1980s and 1990s, and currently generate nearly as much revenue as supermarkets. Thus, it is not surprising that the grocery industry believes itself to be in competition with mass merchandisers.

There has been very little empirical research on shopping at mass merchandisers and other non-grocery formats, despite their growing importance, due to the lack of data on cross-format purchases. Store choice research has focused almost exclusively on grocery stores. It is problematic to generalize from this work to other retail formats, however, because grocery stores differ systematically from other formats in their marketing policies.

For example, grocers tend to offer higher prices, fewer product categories, larger assortments within categories (i.e., more product variants), and more promotional discounts than mass merchandisers. One marketing policy which has been shown to affect shopping behavior and patronage patterns is product assortment. In common product categories, grocers tend to offer far more product alternatives than mass merchandisers, which in turn offer more product alternatives than drug stores. Recent studies indicate that grocers offer more than three times the assortment of mass merchandisers, and more than four times the assortment of drug stores. These extensive assortments are usually offered at a cost of either breadth of product variety (i.e., there are fewer, less diverse product categories at grocery stores than mass merchandisers) or larger stores (i.e., grocery stores have more floor space than drug stores).

Previous research on store choice and store sales have also shown the importance of retailer prices and promotions on shopping behavior. Retailer promotions are also well known to affect shopping behavior. Some studies indicate that mass merchandisers tend to favor the lowest-priced format, offering prices that average 7% and 9% less than drug and grocery stores, respectively, and regular shelf prices that average 11% and 10% less than drug and grocery stores, respectively. Promotional discounts are deepest at the drug store chain, followed in order by grocers and mass merchandisers. Similarly, the highest percentage of promotional sales are made at drug stores, followed in order by grocers and mass merchandisers. Comparative promotional levels are consistent with the observation that the drug chain's regular shelf prices are higher than other formats, but the average prices paid at the drug chain are actually lower than at grocery stores.

Nevertheless, recent studies do not indicate that price-sensitive consumers will patronize mass merchandisers, the lowest-priced format, inordinately. Even though average prices at grocery stores may be higher, their more extensive assortments and deeper discounts may provide more fertile ground for search than mass merchandisers, making them attractive to price-sensitive shoppers. Likewise, the even deeper discounts at the drug chain may also attract price-sensitive shoppers. Previous research using cross-sectional and panel data also suggests that demographics can influence price sensitivity. Thus, many factors are clearly at play in determining consumer shopping behavior.

Evaluating and assessing the retail location variable is, therefore, an extremely complicated process which is affected by both factors inherent to and external to the proposed retail establishment. Recent efforts to investigate the competition for customers and expenditures between grocery stores and mass merchandisers have sought to identify determinants of shopping behavior across retail formats and to determine how the factors that affect shopping behavior differ across retail formats. New techniques have recently been introduced which facilitate the recording and compiling of data regarding shopping behavior across retail formats. A commercially available panel dataset, such as the one syndicated by Information Resources Inc. (IRI), is a prime example of one such technique.

Commercially available panel datasets, like the IRI panel dataset, are different from other shopping panels in that the panelists use wand scanners in their homes to record purchases at all retail formats and outlets, including those stores whose scanner data is not collected in-store by IRI. Additionally, the IRI panel dataset is able to quantify such variables as the interval between shopping trips, the spending per trip, the road distances and travel times between panelists, the closest stores of each shopping chain, the prices, features and temporary price reductions, as well as other causal data. Moreover, the demographics of the individual panelists is also documented and compiled. These more complete household purchase records have enabled the analysis of shopping and spending across grocery stores, mass merchandisers, and drug stores with a rich set of predictors.

While the IRI panel dataset method has improved the compiling and recording of data regarding shopping behavior across retail formats, a need exists for an improved and more comprehensive method of analyzing the data to assist in the evaluation and assessment of prospective commercial retail sites. Further, a need exists for an improved method of accurately correlating the IRI panel dataset to broader population bases. A need also exists for an improved method for projecting revenue and market share of prospective commercial retail locations based upon a correlation of IRI panel datasets to broader population bases and retail formats.

### SUMMARY OF THE INVENTION

The present invention comprises a novel business method for evaluating prospective commercial retail sites. The present invention assists in the evaluation and assessment of prospective sites by forecasting revenues and assessing impact on existing retail establishments. The present invention is also adaptable to forecasting the effects of closing a remotely located retail store based upon the revenues of another existing store. The present invention also overcomes many of the disadvantages of prior art by more accurately correlating syndicated panel data to larger population groups.

The present invention comprises a two-step approach that involves the application of a sophisticated new statistical methodology, called a hierarchical multivariate tobit model, to syndicated panel data in order to forecast the revenues and market shares of prospective retail stores. This modeling and forecasting approach permits the prospective evaluation of alternative retail sites. Further, the modeling and forecasting approach of the present invention may also assist in the assessment of closing existing retail stores on the revenues of prospective stores, as well as other existing stores. Thus, given prospective store sites, the present invention assists in forecasting revenues for stores opened at those sites, as well as an assessment of the impact on existing stores. Moreover, the present invention assists in evaluating and forecasting the effects of a closure of an existing store on another existing store's revenues.

### BRIEF DESCRIPTION OF THE DRAWINGS

A more complete understanding of the method and apparatus of the present invention may be had by reference to the following detailed description when taken in conjunction with the accompanying drawings, wherein:

FIG. 1 is a flow chart of the method of the present invention.

Where used in the various figures of the drawing, the same numerals designate the same or similar parts.

### DETAILED DESCRIPTION OF THE INVENTION

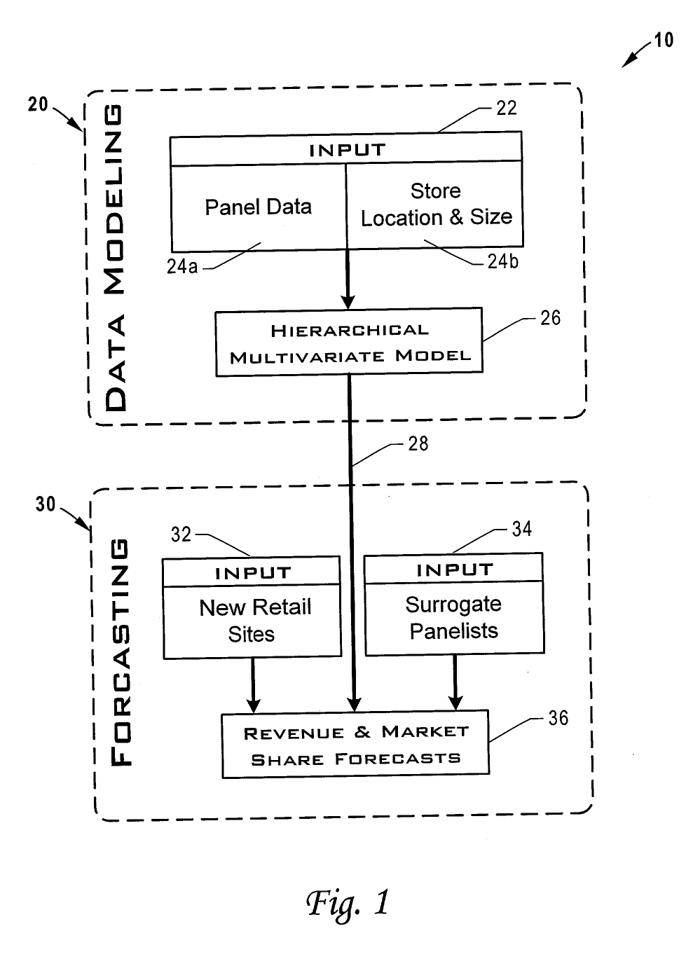

As shown in FIG. 1, the method of the present invention comprises a two-step approach 10 that involves the application of a sophisticated new statistical methodology, called a hierarchical multivariate tobit model 26, to syndicated panel data 24a in order to forecast the revenues and market shares of prospective retail stores. This modeling and forecasting approach permits the evaluation of alternative retail sites and the assessment of closing existing of retail stores on the revenues of prospective stores, as well as existing stores. In other words, given prospective store sites, the method of the present invention permits the forecasting of revenues for stores opened at those sites, as well as an assessment of the impact on existing stores. Further, given the closure of an existing store, the method of the present invention forecasts the effect of the closure on other existing stores' revenues.

### Data Modeling

A. Inputs

In order to estimate models that capture the responsiveness of representative consumer households to retail locations and store sizes, the method of the present invention requires two types of data: shopping panel data 24a, and the locations and sizes of existing stores 24b.

i. Panel Data

The shopping panel data 24a is typically procured via syndicated data providers (e.g., Information Resources Inc. (IRI) and A. C. Nielsen) that collect and disseminate pertinent panel datasets. These syndicated data providers regularly recruit panelists in geographic markets around the country, requiring the panelists to record all of their retail purchases. Purchases are typically recorded using wand scanners in-home or written purchase diaries. Purchases at all relevant retail formats and outlets are thereby captured. The resulting household purchase records provide a database with a rich set of predictors by which to analyze shopping and spending behaviors across multiple retail formats, e.g., grocery stores, mass merchandisers, and drug stores.

The purchase records that comprise the panel dataset are further supplemented with demographic information and physical locations for each panel household. The aforementioned syndicated data sources routinely provide supplementary demographic information and provide panelist location information at the “zip +4” level. Panel household locations are necessary to compute travel distances between shoppers' homes and nearby stores with minimal error. As mentioned previously, travel distance is one of, but not the only important retail location factor.

ii. Store Locations and Sizes

For the relevant retailers in the market, i.e., those retailers which are in the competitive set of the particular retailer being analyzed, the method of the present invention requires locations and sizes of all stores 24b in the market. Sizes (e.g., square footage) may be comprised of the selling floor area or the total footprint area of a store, so long as the measure is consistent across retailers. In addition, the opening date for stores opened during the period of panel data collection is required in order to determine which stores were available to the panelists during the period that their purchases were recorded.

B. Modeling the Data—Hierarchical Multivariate Tobit Model

The method of the present invention estimates an econometric model on the data that incorporates consumer decisions about both “where and when to shop” and, conditional on shopping, i.e., “how much to spend.” The model further specifies that these two shopping decisions depend on characteristics of nearby retail stores, along with time-related factors. How individual households respond to these store characteristics and time-related factors is allowed to vary with known factors (i.e., demographic) and random factors. Moreover, the model's specification further permits the shopper's decisions at one store to influence her decision at other retailers. Thus, the model accounts for retail competition.

i. Tobit Model

The panel household's spending decision (i.e., how much to spend in a given period) at each of the retailers of interest is modeled as a regression, with the log of the household's expenditures during the period at that retailer as the continuous dependent variable. Depending upon the number of retailers considered and shoppers' propensity to visit the stores of each retailer, a large number of the periodic expenditure observations will be zeros, because every household does not shop at each store chain. Thus, in accordance with the Tobit model, the continuous spending variable is censored. Specifically, the regression is conditioned on a binary probit model that captures whether or not any expenditures were observed (i.e., whether the particular store chain was visited during that period).

The variable of interest in our model, yₕᵢₜ, is the expenditures made by household h (indexed h=1, . . . , H) during a period (t=1, . . . , D at chain i (i=1, . . . , S). Expenditures are observed only when an indicator variable for household h's patronage at chain i at time t, zₕᵢₜ, takes the value of 1. The observational equation for yₕᵢₜ is:

$${y}_{hit} = \{ \begin{matrix} {y}_{hit}^{*} if {z}_{hit} = 1 \\ 0 otherwise\end{matrix} \qquad ( 1 )$$

where the model for the logarithm of the latent variable, y*ₕᵢₜ is:

1n(y*ₕᵢₜ)=x′ₕᵢₜβₕᵢεₕᵢₜ (2)

Since zₕᵢₜ is a binary variable, we use a probit model to describe its behavior:

$${z}_{hit} = \{ \begin{matrix}1 if {z}_{hit}^{*} \geq 0 \\ 0 otherwise\end{matrix} \qquad ( 3 )$$

The latent variable, z*ₕᵢₜ, is modeled through a linear model:

z*ₕᵢₜ=x′ₕᵢₜθₕᵢ+uₕᵢₜ (4)

Our model incorporates both the binary choice of store patronage (e.g., will the household shop at Wal-Mart?), and the continuous decision of how much to spend at that store, given patronage. Note that the second decision is not spending per trip, but total spending during a given month at the chain. Thus, it may include multiple trips.

The predictors, xₕᵢₜ, used in equations (2) and (4) are the same, as is characteristic of tobit models. This requirement may be relaxed, in which case the model generalizes to a broader class of discrete (e.g., was the retailer patronized?) and continuous (e.g., given patronage, how much was spent?) models. In such models, different predictors are specified for the two shopping decisions. Because the same retailer characteristics are likely to influence retail patronage and purchase quantities, however, we specify the predictors for equations (2) and (4) to be the same.

If we restrict the predictors to influence the shopper's patronage and conditional spending decisions in exactly the same way (βₕᵢ=θₕᵢ), our model is a standard type 1 tobit (see Amemiya, 1985, for a typology of tobit models). Alternatively, we may permit the predictors to influence a shopper's patronage decision differently from her spending decision (βₕᵢ≠θₕᵢ), and estimate different coefficients for equations (2) and (4). Consider the effect of travel time, for example. Stores that are farther from a shopper's home are less likely to be patronized. Given patronage, however, shoppers may spend more on each trip at such stores in order to allocate the higher travel cost across more purchases (Fox, Metters, and Semple, 2002). Consequently, we estimate βₕᵢ and θₕᵢ separately. The resulting specification is a type 2 tobit model (see Amemiya, 1985, for this typology).

A third alternative approach which may be applied to this problem is to model the number of visits made to the stores of each retailer with a type 1 tobit model, and simultaneously specify the spending per visit with a conditional regression model. Such an approach would involve redefining yₕᵢₜ in equations (1) and (2) as the number visits made by household h to store chain i during period t. This approach also requires restricting βₕᵢ=θₕᵢ and estimating two new equations for spending per visit:

$${w}_{hit} = \{ \begin{matrix} {w}_{hit}^{*} if {z}_{hit} = 1 \\ 0 otherwise\end{matrix} \\ ln ( {w}_{hit}^{*} ) = {x}_{hit}^{′} {α}_{hi} + {ξ}_{hit}$$

where wₕᵢₜ is the observed spending of household h at store chain i during period t, divided by yₕᵢₜ. The system of equations required for this alternative approach would comprise a type 3 tobit model (see Amemiya, 1985, for this typology). Extension of the estimation from the types 1 and 2 tobit model to this model is straightforward

ii. Bayesian Hierarchy

As the household subscripts of the coefficient vectors in equations (2) and (4) suggest, households are allowed to have different response coefficients. In this way, the model accommodates individual differences in response to the predictors. Specifically, the response coefficients are modeled as a function of known and unknown (random) factors. This is accomplished by using a hierarchical Bayesian specification of the coefficients. Hierarchical Bayesian models capture individual differences better than alternative methods and, of greater importance in light of our application, exhibit superior out-of-sample prediction (Allenby and Rossi, 1999; Jacquier and Jarrow, 2000). Like Ainslie and Rossi's (1998) brand choice model, we specify household-level preferences to be systematically affected by household characteristics, or demographics. For expenditure model intercepts:

βₕᵢₜ=d′ₕδᵢ+ξₕᵢₜ (5)

and for patronage model intercepts:

θₕᵢₜ=d′ₕᵢ+ψᵢ+τₕᵢₜ (6)

where dₕ is a vector of household demographics—a more detailed discussion of these predictors is presented below. δᵢ and ψᵢ are parameter vectors relating household h's demographics to its response coefficients for the conditional spending and patronage models, respectively. Together, equations (5) and (6) define a Bayesian hierarchical specification of individual response coefficients.

ii. Multivariate Structure

The hierarchical tobit models for each retailer are linked in a multivariate framework by allowing errors to be correlated. The vector of household residuals from the log expenditure models, εₕₜ=[εₕ₁ₜεₕ₂ₜ . . . ε_{hSt}]′, is assumed to follow a multivariate normal distribution: εₕₜ˜MVN(0,Σ). The vector of household residuals from the patronage models, uₕₜ=[uₕ₁ₜuₕ₂ₜ . . . u_{hSt}]′, is also assumed to follow a multivariate normal distribution: uₕ˜MVN(0,Λ). Because equations (2) and (4) use the same predictors, we must assume that εₕₜ and uₕₜ are independent in order to identify the model. In my empirical applications, correlations between the patronage and conditional spending residuals have been negligible, supporting the validity of this assumption. Prediction errors for conditional spending models are expected to be correlated across store chains, because excess expenditures in one store should result in less spending at other stores. For example, if it is assumed that a household allocates a portion of its budget to perishable items, any perishable purchases at one retailer should substitute for perishable purchases at the others. Because household-level budget constraints are not modeled explicitly, negative residual correlations are expected across the conditional spending equations. Alternatively, patronage and spending models may be specified in a selection framework, allowing errors to be correlated across decisions rather than across stores. However, given the practical inability to include cross-effects in our model (due to multicollinearity), cross-effects must be allowed to enter in reduced form by structuring the error covariance matrices across stores.

Relationships in a household's responses at different store chains are also allowed by specifying error correlations for the hierarchy—equations (5) and (6). The vector of residuals for equation (5), which models household-level preferences for store spending, ξₕₜ=[ξₕ₁ₜξₕ₂ₜ . . . ξ_{hSt}]′, is assumed to follow a multivariate normal distribution: ζₕₜ˜MVN(0,V_{α}). Similarly, the residual vector for equation (6), which models household-level preferences for store patronage, τₕₜ=[τₕ₁ₜτₕ₂ₜ . . . τ_{hSt}]′, is assumed to follow a multivariate normal distribution: τₕₜ˜MVN(0,Vₜ). The specification of error correlations for equations (2), (4), (5) and (6) also improves the efficiency of parameter estimation as in seemingly-unrelated regression (Zellner 1962).

Only recently have Markov Chain Monte Carlo methods for estimating the posterior distributions of the parameters in high dimensional models become available (Gelfand and Smith, 1990; Casella and George 1992; also see Chib, 1993, for application to the tobit specification).

iv. Predictors of Shopping Behavior

The vector of predictor variables, xₕᵢₜ, that applies to household h at chain i during period t is comprised of store-specific and time-dependent variables. Because the objective of the present invention is to develop accurate forecasts given physical changes in retail stores, store-specific predictors relate to store location and size. The store-specific predictors may be changed and varied at the analyst's discretion. For example, in one embodiment of the method of the present invention the store-specific predictors are as follow:

Travel distance—defined as the distance in miles between the panelist's home and the closest store of a given retailer. Both own-effects and cross-effects are estimated. That is, the distance from the shopper's home to the most proximate store of the target retailer (own-) and all other retailers being modeled (cross-) are included as predictors.

Store size—defined as the area in square feet of the closest store of a given retailer. Again, both own-effects and cross-effects are estimated.

Retail density—also known as “agglomeration,” defined as the number of stores within a given radial distance of the retailer's closest store to the panel household. This variable captures the extent to which the store is located in a retail center which might serve as a shopping destination. This predictor is developed by computing the distances between stores in the market, given store location information.

Interactions—defined as the interactions between travel distance and store size, travel distance and retail density, and store size and retail density. Interactions allow one variable (e.g., travel distance) to have a greater or lesser effect, depending upon the level of a moderating variable (e.g., retail density). For example, one might predict that travel distance would have less of an effect on store patronage if the store were located in a major retail center than if it were isolated from other stores.

Two time-dependent variables have also been used as predictors in the development of this embodiment of the method of the present invention:

Seasonality—defined as indicator variables for the season (e.g., a vector of three dummy variables for the first, second, third and fourth quarters of the year). This variable captures systematically higher or lower spending at different times of the year.

Trend—defined as a variable for the consecutive periods in the estimation dataset. This variable captures systematic increases or decreases in spending or patronage over time.

Recall that equations (5) and (6) specify household-level coefficients that have a deterministic component based on known demographics. Previous research using cross-sectional (Blattberg et. al. 1978, and Hoch et al. 1995) and panel data (Ainslie and Rossi, 1998) suggests that demographics can influence price sensitivity. Because shopping behavior is affected by price sensitivity, they are included as predictors in the hierarchies. Thus, the vector of demographic variables, dₕ, may be comprised of the following criteria:

household income, measured in thousands of dollars,

family size, which is the number of household members,

home ownership, an indicator variable (1=yes),

education, an indicator variable (1=yes),

working adult female, an indicator variable (1=yes), and

the presence of a young child (age 0-6) in the home, also an indicator variable (1=children present).

### Revenue and Market Share Forecasting

As stated previously, one of the objectives of the present invention is to forecast the revenues and market shares of existing and prospective stores in the market, given either prospective store sites and/or store closures. This may be accomplished by applying estimates from the hierarchical multivariate tobit model to retail scenarios, which reflect the prospective new stores and/or store closures.

A. Inputs As shown in broad overview in FIG. 1, in order to forecast household level-spending at retail stores using estimates from the hierarchical multivariate tobit model, additional inputs are needed. Sites and sizes of prospective new stores and store closures are required. These inputs enable development of scenarios to which the model estimates can be applied. Though not required, the predictive accuracy of the forecasts is improved by gathering information on additional, or “surrogate” panelists, as discussed below.

i. Prospective Store Sites

As generally indicated by box 32, the only required inputs for forecasting are the locations and sizes of prospective store sites, and dates of store closures. The more precise the site locations, the more precise the distance measurements that can be made. Again, store sizes may reflect selling floor area or total footprint area, so long as the measurement is consistent across stores.

ii. “Surrogate” Panelists

As generally indicated by box 34, in order to improve the predictive accuracy of retail location changes on store revenues, the sample of panel households may be augmented by gathering information on additional households not included in the panel. The only information required for these “surrogate” panelists is the location of the household (“zip+4” or more precise) and demographic information. Demographic information should include as many of the variables in dₕ as possible (e.g., family size, income, home ownership, working adult female, children aged 6 or below, college education). It is important to note that the more surrogate panelist information that can be gathered to augment the panel data, the better the resulting forecasts.

B. Forecasting Methodology

i. Development of Retail Scenarios

The hierarchical multivariate tobit model estimated in the first step of this approach presumes an accurate characterization of the retail environment (i.e., the sizes and locations of available stores in the geographic market when panelists' shopping decisions were being made). Knowledge of the future retail environment is required for the analyst to forecast household patronage and spending.

In order to forecast future consumer expenditures across stores, alternative scenarios of the future retail environment must be developed. Such scenarios may reflect new store openings or closures. Note that the length of time to be forecast must be determined apriori. An important application of this approach is to develop these alternative scenarios, based on prospective changes to the retail environment, to evaluate the revenue and market share impact of store openings and closures. Thus, this approach can support retail site selection decisions. Another important application of this approach is to develop forecasts based on the openings or closures of competing retailers' stores. In this way, the analyst can assess the impact of competitors decisions on the target retailer's revenues and market share.

The development of alternative retail scenarios is straightforward. Conditioning on the prospective store openings and closures, the household-level vectors of predictor variables, xₕᵢₜ, are computed for the future periods to be forecast. Store-specific variables—travel distances, sizes of the most proximate stores, retail density surrounding the most proximate stores, and interactions of these variables—are computed for those future periods given the prospective store openings and closures. Time-dependent variables (seasonality and trend) are easily extrapolated. Thus, the retail scenarios result in xₕᵢₜ for the periods to be forecast. Note that xₕᵢₜ are determined not only for panelists, but for “surrogate” panelists, as well.

ii. Creation of Store-Level Forecasts

Given predictors in future periods (t>T), patronage and spending for the n₁ panelists and n₂ surrogate panelists can be estimated and, based on those estimates, store-level revenues. Expected revenues for individual store j (j∈i) incorporate expectations of households' probability of patronage and conditional expenditures, summed across all households, h, for whom store j is closest to that household. First, we define the expected revenues at store j of chain i:

$$E ( {R}_{jt} ) = {\sum }_{J} E ( {y}_{hit}^{*} ) Pr ( {z}_{hit} = 1 ) ∋ h ∈ J iif j is the closest store of chain i \qquad ( 7 )$$

where

E(y*ₕᵢₜ)=exp(x′ₕᵢₜ(d′ₕδᵢ))∀t>T (8)

Pr(zₕᵢₜ=1)=Φ((x′ₕᵢₜ(d′ₕψᵢ))∀t>T (9)

Using equations (8) and (9), response coefficients for store-specific and time-dependent variables of the enlarged sample of n₁+n₂ households can be determined, using only demographic information, dₕ, for those households (see Smith, 1972, and Lindley and Smith, 1972, and for details regarding expected values using hierarchical Bayesian models). Thus, in the forecasting step, the analyst need know only household locations to develop the predictors, xₕᵢₜ, and household demographics, dₕ, to develop the response variables. For the n₁ “true” panel households, residuals from the model estimation may be resampled to improve the forecast. Specifically, εₕᵢₜ and uₕᵢₜ from the model estimation can be randomly added to the expected values of yₕᵢₜ and zₕᵢₜ to incorporate additional information about the behavior of certain panelists (i.e., historically under- or over-patronized or under- or overspent, compared to the model predictions)

By summing the expected expenditures for the subset of n₁+n₂ households that are closest to store j of all stores of retailer i, we can forecast the revenues of this store for the retail scenario being examined. Note that a large number of surrogate households, n₂, adds to the stability of these store-level revenue forecasts. By computing expected revenues for all stores of retailer i (including prospective stores opened at a given site), store-level sales increases and decreases due to the retail scenario can be assessed.

iii. Calibration of Forecasts

Scenario-based store revenue forecasts must be calibrated in order to be used for site selection or sales forecasting purposes. Comparing alternative scenario forecasts to a baseline provides such calibration. In other words, forecasting store-level revenues for a scenario with no changes in the retail environment for the forecasting horizon can provide a baseline against which to compare forecasts from more speculative scenarios. By comparing alternative scenario forecasts to such a baseline, proportional changes in revenue and market share can be computed. A second calibration approach is to compute expected store revenues, E(Rⱼₜ), for the n₁+n₂ households for the periods in which the model was estimated (t=1, . . . , T). For the estimation period, actual store sales for the target retailer are observed. By regressing the expected revenues on the observed store sales, the analyst can establish a direct correlation which can then be used to relate revenue forecasts in future periods, t>T, to store sales.

### Application of Method of Present Invention Using Markov Chain Monte Carlo Estimation of a Hierarchical Multivariate Type-2 Tobit Model

In one embodiment of the present invention, the method is applied by first stacking following variables:

the dependent variables of both equations for all households h and time periods t so that y*ᵢ=[y*₁ᵢ₁y*₁ᵢ₂ . . . y*_{HiT}]′ and z*ᵢ=[z*₁ᵢ₁z*₁ᵢ₂ . . . z*_{HiT}]′;

the error terms of both equations for all households h and time periods t so that εᵢ=[ε₁ᵢ₁ε₁ᵢ₂ . . . ε_{HiT}]′ and uᵢ=[u₁ᵢ₁u₁ᵢ₂ . . . u_{HiT}]′; and

the predictor variables shared by the two equations, Xᵢ[x₁ᵢ₁x₁ᵢ₂ . . . x_{HiT}]′.

Contemporaneous correlation of the error terms in equations (2) and (4) is allowed by adopting the SUR forms shown below.

$$[ \begin{matrix}{y}_{1}^{*} \\ {y}_{2}^{*} \\ ⋮ \\ {y}_{S}^{*}\end{matrix} ] = [ \begin{matrix}{X}_{1} & & & \\ & {X}_{2} & & \\ & & ⋰ & \\ & & & {X}_{S}\end{matrix} ] [ \begin{matrix}{β}_{1} \\ {β}_{2} \\ ⋮ \\ {β}_{S}\end{matrix} ] + [ \begin{matrix}{ϵ}_{1} \\ {ϵ}_{2} \\ ⋮ \\ {ϵ}_{S}\end{matrix} ] , \\ [ \begin{matrix}{z}_{1}^{*} \\ {z}_{2}^{*} \\ ⋮ \\ {z}_{S}^{*}\end{matrix} ] = [ \begin{matrix}{X}_{1} & & & \\ & {X}_{2} & & \\ & & ⋰ & \\ & & & {X}_{S}\end{matrix} ] [ \begin{matrix}{θ}_{1} \\ {θ}_{2} \\ ⋮ \\ {θ}_{S}\end{matrix} ] + [ \begin{matrix}{u}_{1} \\ {u}_{2} \\ ⋮ \\ {u}_{S}\end{matrix} ]$$

where, for {i=1, . . . , S}:

εᵢ is an HT vector of disturbances such that E(εᵢ)=0 and E(εᵢεⱼ′)=σᵢⱼI_{HT}, and

uᵢ is an HT vector of disturbances such that E(uᵢ)=0 and E(uᵢuⱼ′)=E(uᵢuⱼ′=θᵢⱼI_{HT},

with

$$\sum = [ \begin{matrix}{σ}_{11} & {σ}_{12} & ⋯ & {σ}_{1 S} \\ {σ}_{21} & {σ}_{22} & ⋯ & {σ}_{2 S} \\ ⋮ & ⋮ & ⋰ & ⋮ \\ {σ}_{S1} & {σ}_{S2} & ⋯ & {σ}_{SS}\end{matrix} ] , Λ = [ \begin{matrix}{λ}_{11} & {λ}_{12} & ⋯ & {λ}_{1 S} \\ {λ}_{21} & {λ}_{22} & ⋯ & {λ}_{2 S} \\ ⋮ & ⋮ & ⋰ & ⋮ \\ {λ}_{S1} & {λ}_{S2} & ⋯ & {λ}_{SS}\end{matrix} ]$$

Finally, for clarity the SUR equations above are rewritten as follows:

y*=Xβ+ε and z*=Xθ+u

Next, the hierarchies associated with the two shopping decisions are also rewritten by stacking the following:

the intercept coefficients for all households h so that Bᵢ=[β₁ᵢβ₂ᵢ . . . β_{Hi}]′ and θᵢ=[θ₁ᵢθ₂ᵢ . . . θ_{Hi}]′;

the common predictor variables for the two equations, D=[d₁d₂ . . . d_{H}]′; and

the error terms of the hierarchical equations for all households h, [symbol] ᵢ=[ξ₁ᵢξ₂ᵢ . . . ξ_{Hi}]′and Tᵢ=[τ₁ᵢτ₂ᵢ . . . τ_{Hi}]′.

A multiple regression is thereupon specified using the SUR format, as shown below.

$$[ \begin{matrix}{B}_{1} \\ {B}_{2} \\ ⋮ \\ {B}_{S}\end{matrix} ] = [ \begin{matrix}D & & & \\ & D & & \\ & & ⋰ & \\ & & & D\end{matrix} ] [ \begin{matrix}{δ}_{1}^{′} \\ {δ}_{2}^{′} \\ ⋮ \\ {δ}_{S}^{′}\end{matrix} ] + [ \begin{matrix}{Ξ}_{1} \\ {Ξ}_{2} \\ ⋮ \\ {Ξ}_{S}\end{matrix} ] , \\ [ \begin{matrix}{θ}_{1} \\ {θ}_{2} \\ ⋮ \\ {θ}_{3}\end{matrix} ] = [ \begin{matrix}D & & & \\ & D & & \\ & & ⋰ & \\ & & & D\end{matrix} ] [ \begin{matrix}{ψ}_{1}^{′} \\ {ψ}_{2}^{′} \\ ⋮ \\ {ψ}_{S}^{′}\end{matrix} ] + [ \begin{matrix}{T}_{1} \\ {T}_{2} \\ ⋮ \\ {T}_{S}\end{matrix} ]$$

where, for {i 1, . . . , S} and demographic variable s {k=1, . . . , K}:

ξᵢ is an H vector of disturbances such that E(ξᵢ)=0 and E(ξᵢξ′ᵢ)=ν^{α}ᵢᵢI_{H}, and

τᵢ is an H vector of disturbances such that E(τᵢ)=0 and E(τᵢ)=νᵢᵢI_{HT}

with

$${V}_{α} = [ \begin{matrix}{v}_{11}^{α} & & & \\ & {v}_{22}^{α} & & \\ & & ⋰ & \\ & & & {v}_{KS , KS}^{α}\end{matrix} ] , {V}_{i} = [ \begin{matrix}{v}_{11}^{i} & & & \\ & {v}_{22}^{i} & & \\ & & ⋰ & \\ & & & {v}_{KS , KS}^{i}\end{matrix} ]$$

Thus, the preceding SUR equation may be summarized as: B=Dδ+ [symbol] and θ=DΨ+T.

Both the SUR structures of the models detailed above and the hierarchical specification preclude analytical solutions of the S-model system of equations under consideration. Moreover, the high dimension of the integral makes the use of numerical integration techniques infeasible for the systems of equations. Due to the limitations of analytical and numerical estimation techniques for the hierarchical multivariate Tobit specification, a Gibbs Sampler is used to estimate the marginal distributions of the latent dependent variables, parameters and covariances. The Gibbs Sampler comprises a sequential sampling from the relevant conditional distributions over a large number of iterations. These draws can be shown to converge to the marginal posterior distributions. The implementation of the Gibbs Sampler for this application of the method of an embodiment of the present invention, comprises the three steps which follow.

A. Conditional Distributions

The first implementation step requires that the conditional distributions of the relevant variables are specified. The solutions of these distributions follow from the normality assumption of the disturbance terms. Natural conjugate priors are employed. Specifications of the conditional distributions are as follows:

y*ₕᵢₜ is yₕᵢₜ if y*ₕᵢₜ>0, otherwise y*ₕᵢₜ is drawn from a normal distribution, truncated above at 0.

$${y}_{hit}^{*} \vert {y}_{h , j \neq i , t}^{*} , {β}_{hi} , \\ \sum \sim \{ \begin{matrix}{y}_{hit} \vert {y}_{hit} > 0 \\ {N}_{T} ( {m}_{hit} {β}_{hi} - {σ}_{ij} {\sum }_{jj}^{- 1} {y}_{h , j \neq i , t} , {σ}_{ii} - {σ}_{ij} {\sum }_{jj}^{- 1} {σ}_{ji} ) otherwise\end{matrix} \\ with {y}_{ht}^{*} = [ \frac{{y}_{hit}^{*}}{{y}_{h , j \neq i , t}^{*}} ] and \sum = [ \frac{{σ}_{ii}}{{σ}_{ji}} + \frac{{σ}_{ij}}{{\sum }_{jj}} ]$$

As the notation suggests, the y*ₕᵢₜ vector and Σ matrix are partitioned between the store chain of interest, i, and all other store chains, j≠i. Without loss of generality, the store chain of interest is shown to be the first. Each chain is then drawn in succession for household h, conditioning on y*_{h,i≠j,t}, a vector of latent dependent variables for all j≠i, and Σ.

The truncated normal variates are drawn using the inverse cdf method. Given the truncation value of zero, the conditional expected value of the dependent variable,

$$E ( {y}_{hit}^{* ( i )} ) \vert {y}_{h , j \neq i , i}^{* ( i - 1 )} , {β}_{hi}^{( i - 1 )} , {\sum }^{( i - 1 )} = {x}_{hit} {β}_{hit}^{( i - 1 )} - {σ}_{ij}^{( i - 1 )} {\sum }_{jj}^{- 1 ( i - 1 )} ( {y}_{h , j \neq i , i}^{* ( i - 1 )} - E ( {y}_{h , j \neq i , i}^{* ( i - 1 )} ) ) ,$$

and the conditional standard deviation of the dependent variable,

$${σ}_{{y}^{*}}^{( i - 1 )} \vert {\sum }^{( i - 1 )} = {σ}_{ii}^{( i - 1 )} - {σ}_{ij}^{( i - 1 )} {\sum }_{jj}^{- 1 ( i - 1 )} {σ}_{ji}^{( i - 1 )} ,$$

the truncated normal values are drawn using the following procedure. (Note that conditioning arguments are dropped for clarity):

Compute the upper limit for uniform interval:

L=Φ[(0−E(y*ₕᵢₜ^{(t)}))/σ_{y*}^{(t-1)}]

where Φ[.] represents the Normal cdf.

Draw a uniform variate: U˜Uniform(0,L).

Compute the realized value of the uniform draw:

y*ₕᵢₜ^{(t)}=Φ⁻¹(U)σ_{y*}^{(t-1)}+E(y*ₕᵢₜ^{(t)})

Note that, when using this procedure, values of U approaching 0 tend toward −∞ while values of U approaching L tend toward zero, the truncation point.

2. In a similar fashion, the latent dependent variable values for the probit component of the model are drawn. If the indicator variable zₕᵢₜ=1, then z*ₕᵢₜ is drawn from a normal distribution, truncated below at 0. Otherwise, z*ₕᵢₜ is drawn from a normal distribution, truncated above at 0.

z*ₕᵢₜ|z*_{h,j≠i,t},θₕᵢ,tΛ˜N_{T}(xₕᵢₜθₕᵢ−λᵢⱼΛⱼⱼ⁻¹z*_{h,j≠i,t},λ_{ii -λ}ᵢⱼΛⱼⱼ⁻¹λⱼᵢ)

where:

$${z}_{ht}^{*} = [ \begin{matrix}{z}_{hit}^{*} \\ -- \\ {z}_{h , j \neq i , t}^{*}\end{matrix} ] and Λ = [ \begin{matrix}{λ}_{ii} & \vert & {λ}_{ij} \\ -- & + & -- \\ {λ}_{ji} & \vert & {Λ}_{jj}\end{matrix} ]$$

As in the conditional spending model, the latent probit dependent variables are drawn using the inverse cdf method with mean and variance as follows:

E(z_{hit*}^{(t)})|z*_{h,j≠i,t}^{(t-1)},θₕᵢ^{(t-1)}, Λ^{(t-1)}=mₕᵢₜθₕᵢ^{(t-1)}−λᵢⱼ(t−1)Λⱼⱼ^{-1(t-1)}(z*_{h,j≠i,t}^{(t-1)}E(z*_{h,j≠i,t}^{(t-1)}))

λ_{y*}^{(t-1)}|Λ^{(t-1)}=λᵢᵢ^{(t-1)}−λᵢⱼ^{(t-1)}Λⱼⱼ^{-1(t-1)}λⱼᵢ^{(t-1)}

3. The vector of household parameters β_{b} is drawn from a SUR model with variance/covariance matrix of disturbances Σ.

βₕ^{(t)}|y*^{(t)},Σ^{(t-1)},V_{α}^{(t-1},δ^{(t-1)}, \overline{β}ₕ˜N((X′ₕ(Σ^{-1(t-1)}\mathring{×}I_{T})y*ₕ+V_{α}^{(t-1)}Dₕδ^{(t-1)})Q,Q)

where: Q=(X′ₕ(Σ^{-1(t-1}\mathring{×}I_{T})Xₕ+V_{α}^{(t-1)-1})^{⁻¹}.

4. The vector of household parameters θₕ is also drawn from a SUR model with variance/covariance matrix of disturbances Λ.

θₕ^{(t)}|z*^{(t)},Λ^{(t-1)},Vᵢ^{(t-1)},Ψ^{(t-1)},\overline{θ}ₕ˜N((X′ₕ(Λ^{-1(t-1)}\mathring{×}I_{T})z*ₕ^{(t)}+Vₜ^{(t-1)}Dₕψ^{(t-1)})R,R)

where: R=(X′ₕ(Λ^{-1(t-1)}\mathring{×}I_{T})Xₕ+Vₜ^{(t-1)-1})^{⁻¹}.

5. The vector of hyper-parameters, δ, is drawn from a SUR model with variance/covariance matrix of disturbances, V_{α}

δ^{(t)}|B^{(t)},V_{α}^{(t-1)},V_{δ},\overline{δ}˜N((D′(V_{α}^{(t-1)}\mathring{×}I_{H})B+V_{δ\overline{δ})}S,S)

where: S=(D′(V_{α}^{-1(t-1)}\mathring{×}I_{H})D+V_{δ}⁻¹)^{⁻¹}

6. The vector of hyper-parameters, Ψ, is drawn from a SUR model with variance/covariance matrix of disturbances, Vᵣ.

ψ^{(t)}|Θ^{(t)},Vₜ^{(t-1)},V_{ψ},\overline{ψ}˜N((D′(Vₜ^{-1(t-1)}\mathring{×}I_{H})Θ+^{V}_{ψ}\overline{ψ})T,T)

where: T=(D′(Vₜ^{-1(t-1)}\mathring{×}I_{H})D+V_{ψ}⁻¹)^{⁻¹}

7. Σ is drawn from an inverted Wishart distribution with HT+ν_{Σ}degrees of freedom.

Σ^{-1(t)}|B^{(t)},y*(t),δ(t), Σ^{(t)},V_{α}^{(t)},V_{Σ},84 ₉₃ ˜W(HT+ν_{Σ},(V_{Σ}+εε′)^{⁻¹})

8. A is also drawn from an inverted Wishart distribution with HT+VA degrees of freedom.

Λ^{-1(t)}|Θ^{(t)},z*^{(t)},ψ^{(t)},Λ^{(t)},Vₜ^{(t)},V_{Λ},ν_{Λ}˜W(HT+ν_{Λ},(V_{Λ}+uu′)^{⁻¹})

9. V^{α}_{hk,hk} is drawn from an inverse χ² distribution with HT+ν_{α} degrees of freedom.

ν_{hk,hk}^{α-1(t)}|ω^{(t)}y*^{(t)},δ^{(t)},V_{α}^{(t)},ν_{α}˜χ²(H+ν_{α},(\overline{V}_{α}+ξξ′)^{⁻¹})

10. V^{t}_{hk,hk} is drawn from an inverse χ² distribution with HT+νₜ degrees of freedom.

ν_{hk,hk}^{t-1(t)}|Θ^{(t)}z*^{(t)},ψ^{(t)},Vₜ^{(t)},\overline{V}ₜ,νₜ˜χ²(H+νₜ,(\overline{V}ₜ+ττ′)^{⁻¹})

B. Prior Distributions

The second implementation step comprises specifying prior distributions for the parameters of interest:

The prior distribution of δ is MVN(δ,V_{δ}), where δ=0 and V_{δ}=diag(10³).

The prior distribution of Ψ is MVN(Ψ,V_{Ψ}), where Ψ=0 and V_{Ψ=diag(}10³).

The prior distribution of ε⁻¹ is Wishart: W(ν_{Σ},V_{Σ}), where ν_{Σ}=10 and V_{Σ}=diag(10⁻³).

The prior distribution of Λ⁻¹ is Wishart: W(ν_{Λ},V_{Λ}), where ν_{Λ}=10 and V_{Σ}=diag(10⁻³).

The prior distribution of ν^{α}_{hk,hk}⁻¹ is χ²:χ²(ν_{α},V_{α}), where ν_{α}=1 and V_{α}=diag(10⁻³).

The prior distribution of ν^{t}_{hk,hk}⁻¹ is χ²:χ² (νₜ,Vₜ), where νₜ=1 and Vₜ=diag(10⁻³).

Note that the prior distributions are set to be non-informative so that inferences are driven by the data.

C. Initial Values

The third implementation step comprises setting the initial values for the parameters of the marginal distributions. The starting values for Phi from equation (2) are computed by OLS, using 1n(yₕᵢₜ) as the dependent variable of the regression. The covariance matrix, Σ, is initiated by taking the residuals of the OLS regression, εₕₒₜ, (conditioned on the initial parameter values) and using them to compute sample covariances. In a similar fashion, the starting values for the patronage equation parameters, θᵢ, are computed by OLS, using zₕᵢₜ as the dependent variable. Again, the residuals from this regression, uₕᵢₜ, are used to compute the sample covariances, which serve as the initial value for Λ. Note that other initial values were used to ensure that estimates were not dependent on a particular starting point.

The final step is to generate N₁+N₂ random draws from the conditional distributions. The number of initialization iterations, N₁, is determined empirically. A “burn in” period of 3500 iterations is typically used. To reduce auto-correlation in the Gibbs draws, only every fifth draw is used in the sequence that comprises N₂ for the estimation. In this way, the last N₂ iterations are used to estimate marginal posterior distributions of the parameters of interest. Note that the means and variances of these distributions are computed directly using the means and variances of the final N₂ draws of each parameter.

It will now be evident to those skilled in the art that there has been described herein an improved computer-based method for evaluating and assessing prospective commercial retail sites by forecasting revenues and assessing impact on existing retail establishments Although the invention hereof has been described by way of a preferred embodiment, it will be evident that other adaptations and modifications can be employed without departing from the spirit and scope thereof. For example, some of the steps in the system procedure could be conducted mechanically in addition to those conducted electronically. The terms and expressions employed herein have been used as terms of description and not of limitation; and thus, there is no intent of excluding equivalents, but on the contrary it is intended to cover any and all equivalents that may be employed without departing from the spirit and scope of the invention.

1. A method of estimating the revenue and market share of a prospective store based upon a proposed location comprising the steps of:
(a) identifying the proposed location;
(b) assigning a size to the prospective store;
(c) accessing a first set of data;
(d) creating a second set of data by modifying the first set of data based on the location and size of the prospective store;
(e) establishing a retail area surrounding the proposed location;
(f) modeling a buyer population within the retail area based on the second set of data; and
(g) estimating the revenue and market share of the proposed store based on the modeled buyer population.

2. A method of estimating the revenue and market share of a first store based upon a the closing of a second store comprising the steps of:
(a) identifying the first and second stores;
(b) accessing a first set of data;
(c) creating a second set of data by modifying the first set of data based on the closing of the second store;
(d) establishing a retail area surrounding the first store;
(e) modeling a buyer population within the retail area based on the second set of data; and
(f) estimating the revenue and market share of the first store based on the modeled buyer population.

3. A method of estimating the revenue and market share of a first store based upon a the opening of a second store comprising the steps of:
(a) identifying the first and second stores;
(b) accessing a first set of data;
(c) creating a second set of data by modifying the first set of data based on the opening of the second store;
(d) establishing a retail area surrounding the first and second stores;
(e) modeling a buyer population within the retail area based on the second set of data; and
(f) estimating the revenue and market share of the first store based on the modeled buyer population.
